(19) United States
(12) Patent Application Publication
(10) Pub. No.: US 2022/0159910 A1
(43) Pub. Date: May 26, 2022

(54) SYSTEMS AND METHODS FOR MANAGING PLANT DATA AND PLANT GROWTH

(71) Applicant: Grobo Inc., Waterloo (CA)

(72) Inventors: Bjorn Dawson, Waterloo (CA); Jason Kent, Waterloo (CA); Stephen Campbell, Waterloo (CA); Bruno Alfano-Rizzo, Waterloo (CA)

(21) Appl. No.: 17/535,137

(22) Filed: Nov. 24, 2021

Related U.S. Application Data
(60) Provisional application No. 63/117,608, filed on Nov. 24, 2020.

(51) Int. Cl. A01G 7/04; A01G 9/24; G06K 7/14; A01G 9/00

(52) U.S. Cl. CPC A01G 7/045; A01G 2009/003; G06K 7/1417; A01G 9/24

(57) ABSTRACT

Provided herein is a computer-implemented method of managing plant data. The method includes storing first plant data on a user device connected to a server. The first plant data relates to growth of a plant in a first grower device. The method also includes collecting second plant data related to growth of the plant in a second grower device. The second grower device is for growth of the plant moved from the first grower device. The second plant data is collected by the second grower device. The method also includes transferring the first plant data and the second plant data to the server. The method also includes displaying the first plant data and the second plant data on the user device.

### TECHNICAL FIELD

The embodiments disclosed herein relate to growing plants and managing plant data, and in particular to systems, methods, and devices for managing plant data and for growing plants.

### INTRODUCTION

Plant grower devices such as hydroponic and aquaponic devices are used for optimizing plant growth at home and in industry. However, conventional systems and methods do not provide a solution for managing plant data for plants that are moved between plant grower devices. Further, plant grower devices are typically designed for early stage growth of plants from seeds and when a plant grows to a particular age or size, the plant grower may no longer be suitable for growing the plant. Further, plant grower devices are typically designed to grow plants from a seed to harvest.

Accordingly, there is a need for an improved systems, methods, and devices for managing plant data and for growing plants. For increased plant growth efficiency it is beneficial to create grow systems that are optimized to grow the plant for a particular length of time and then are transferred to a separate system.

### SUMMARY

According to some embodiments, there is a computer-implemented method of managing plant data. The method includes storing first plant data on a user device to a server. The first plant data relates to growth of a plant in a first grower device. The method also includes collecting second plant data related to growth of the plant in a second grower device. The second grower device is for growth of the plant moved from the first grower device. The method also includes transferring the first plant data and the second plant data to the server. The method also includes displaying the first plant data and the second plant data on the user device.

The method may provide that the first plant data includes at least one of the group comprising plant strain, planting date, a plant name, historical environmental data, breeder information, photos of the plant, and notes related to the plant.

The method may provide that the second plant data is collected by a sensor of the second grower device.

The method may provide that the second plant data includes environmental data.

The method may provide that the environmental data includes at least one of the group comprising temperature, pH, and humidity.

The method may also include generating a dosing plan for providing nutrients to the plant, wherein the dosing plan is generated based on the first plant data.

The method may also include modifying the dosing plan based on the second plant data.

The method may also include optimizing the growth of the plant in the second grower device based on the second plant data.

The method may also include identifying the plant based on an identifier.

The method may provide that identifier is a QR code or a barcode.

The method may also include manually inputting the first plant data into the user device.

The method may provide that the first plant data is collected by the first grower device prior to storing the first plant data on the user device.

According to some embodiments, there is a computer system for managing plant data. The system includes a user device for displaying first plant data and second plant data. The first plant data is related to growth of a plant in a first grower device. The system also includes a server connected to the user device. The server is configured to receive and store the first plant data and the second plant data from the user device. The system also includes a second grower device for growth of the plant after growth of the plant in the first grower device. The second grower device collects second plant data related to growth of the plant in the second grower device. The second grower device sends the second plant data to the user device.

The system may provide that the first plant data includes at least one of the group comprising plant strain, planting date, a plant name, historical environmental data, breeder information, photos of the plant, and notes related to the plant.

The system may provide that the second plant data is collected by a sensor of the second grower device.

The system may provide that the second plant data includes environmental data.

The system may provide that the environmental data includes at least one of the group comprising temperature, pH, and humidity.

The system may provide that the server generates a dosing plan for providing nutrients to the plant, wherein the dosing plan is generated based on the first plant data.

The system may provide that the server modifies the dosing plan based on the second plant data.

The system may provide that the second grower device optimizes the growth of the plant based on the second plant data.

The system may provide that the second plant device identifies the plant based on an identifier.

The system may provide that the identifier is a QR code or a barcode.

The system may provide that a user manually inputs the first plant data into the user device.

The system may provide that the first plant data is collected by the first grower device prior to storing the first plant data on the user device.

According to some embodiments, there is a system for growing plants. The system includes a user device for receiving second plant data. The system also includes a first grower device operably controlled by the user device. The first grower device includes a first growth compartment for growth a plant from a seed and a chamber for storing a liquid nutrient solution. The system also includes a second grower device for receiving the plant grown in the first grower device. The second grower device is operably controlled by the user device. The second grower device collects second plant data related to growth of the plant in the second grower device. The second grower device includes a second growth compartment larger than the first growth compartment and a chamber for storing a liquid nutrient solution.

The system may provide that the first grower device further comprises at least one sensor for collecting first plant data, wherein the first plant data relates to growth of the plant from a seed in the first grower device.

The system may provide that the first plant data includes at least one of the group comprising plant strain, planting date, a plant name, historical environmental data, breeder information, photos of the plant, and notes related to the plant.

The system may provide that the second grower device further comprises at least one sensor for collecting first plant data, wherein the first plant data relates to growth of the plant from a seed in the first grower device.

The system may provide that the second plant data includes environmental data.

The system may provide that the environmental data includes at least one of the group comprising temperature, pH, and humidity.

The system may provide that the server generates a dosing plan for providing nutrients to the plant, wherein the dosing plan is generated based on the first plant data.

The system may provide that a server modifies the dosing plan based on the second plant data.

The system may provide that the second grower device optimizes the growth of the plant based on the second plant data.

The system may provide that the second plant device identifies the plant based on an identifier.

The system may provide that the identifier is a QR code or a barcode.

The system may provide that a user manually inputs the first plant data into the user device.

The system may provide that the first plant data is collected by the first grower device prior to storing the first plant data on the user device.

The system may provide that the first growth compartment further comprises a removable tray.

The system may provide that the removable tray is compatible with the second growth compartment and is for transferring the plant from the first grower device to the second grower device.

According to some embodiments, there is a method for growing plants. The method includes removing a tray containing a plant from a first growth compartment of a first grower device. The method also includes moving the tray containing the plant to a second grower device for receiving the plant grown in the first grower device. The second grower device collects second plant data related to growth of the plant in the second grower device. The method also includes placing the tray containing the plant in a second growth compartment of the second grower device. The second growth compartment is larger than the first growth compartment. The tray is physically compatible with both the first growth compartment and the second growth compartment.

The method also include storing first plant data on a user device to a server. The first plant data relates to growth of a plant in a first grower device. The method may also include transferring the first plant data and the second plant data to the server. The method may also include displaying the first plant data and the second plant data on the user device

The method may provide that the first plant data includes at least one of the group comprising plant strain, planting date, a plant name, historical environmental data, breeder information, photos of the plant, and notes related to the plant.

The method may provide that the second plant data includes environmental data.

The method may provide that the environmental data includes at least one of the group comprising temperature, pH, and humidity.

The method may also include generating a dosing plan for providing nutrients to the plant, wherein the dosing plan is generated based on the first plant data.

The method may include modifying the dosing plan based on the second plant data.

The method may include optimizing the growth of the plant in the second grower device based on the second plant data.

The method may also include identifying the plant based on an identifier.

The method may include the identifier is a QR code or a barcode.

The method may also include manually inputting the first plant data into the user device.

The method may provide that the first plant data is collected by the first grower device prior to storing the first plant data on the user device.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram illustrating a computer system for transferring plant data, in according to an embodiment;

FIG. 2 is a simplified block diagram of components of a mobile device or portable electronic device, according to an embodiment;

FIG. 3 is a flowchart demonstrating a computer-implemented method of managing plant data, according to an embodiment;

FIG. 4 is a block diagram demonstrating a computer system for managing plant data, according to an embodiment;

FIG. 5A is a front view of a plurality of first grower devices, according to an embodiment;

FIG. 5B is a perspective view of the first grower devices from an embodiment shown in FIG. 5A with the growing tray removed;

FIG. 6A is a side view of a tray of a first grower device with growth medium, according to an embodiment;

FIG. 6B is a bottom-up view of the tray from an embodiment shown in FIG. 6A;

FIG. 6C is a perspective view of the tray from an embodiment shown in FIG. 6A inside a first growth compartment;

FIG. 6D is a side view of a tray of a first grower device without growth medium, according to an embodiment;

FIG. 6E is a perspective view of the tray from an embodiment shown in FIG. 6D;

FIG. 7A is a perspective view of another embodiment of a tray of the first growth compartment;

FIG. 7B is a side view of the tray of an embodiment shown in FIG. 7A;

FIG. 7C is a perspective view of the tray of an embodiment shown in FIG. 7A with growth medium;

FIG. 7D is a side view of the tray of an embodiment shown in FIG. 7A with growth medium;

FIG. 8A is a growth medium for growing a seed in a first growth compartment, according to an embodiment;

FIG. 8B is another embodiment of the growth medium in FIG. 8A;

FIG. 9A is a top cover of the first grower device with three trays placed in the top cover, according to an embodiment;

FIG. 9B is the top cover of an embodiment shown in FIG. 9A without a tray;

FIG. 9C is a side view of the top cover of an embodiment shown in FIG. 9A;

FIG. 10A is a user interface on a user device for an application which controls the system for managing plant data, according to an embodiment;

FIG. 10B is the user interface of an embodiment shown in FIG. 10A where a user does not have any first grower devices and only has second grower devices;

FIG. 10C is the user interface of an embodiment shown in FIG. 10A showing each plant being grown in the first grower device;

FIG. 10D is the user interface of an embodiment shown in FIG. 10A showing plant data of a single plant being grown in the second grower device;

FIG. 10E is the user interface of FIG. 10A showing tracking of growth of a plant, according to an embodiment;

FIG. 10F is the user interface of FIG. 10A showing tracking of a user-initiated grow recipe, according to an embodiment;

FIG. 11A is a second grower device in an closed configuration, according to an embodiment;

FIG. 11B is a second grower device of an embodiment shown in FIG. 11A in an open configuration;

FIG. 11C is a perspective view of the second grower device of FIG. 11A in an open configuration without a plant, according to an embodiment;

FIG. 11D is a side view of the top cover of FIG. 11C without a tray, according to an embodiment;

FIG. 11E is a top down view of the top cover of FIG. 11C without a tray, according to an embodiment;

FIG. 11F is a side view of the top cover of the second grower device of FIG. 11C with one tray placed in the top cover, according to an embodiment; and

FIG. 11G, illustrated therein is a top down view of the top cover of the second grower device of FIG. 11C with one tray placed in the top cover, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The term “sensor” refers, without limitation, to the component or region of a device which is configured to detect the presence or absence of a measurable parameter. For example, the sensor may be a pH sensor for detecting the pH level of water that a plant is growing in. The sensor may alternatively be a thermometer for measuring the ambient temperature of the environment the plant is growing in. The sensor may also be a humidity sensor for measuring the ambient humidity level of the environment the plant is growing in.

The term “plant data” refers, without limitation, to data related to the growth of a plant. The plant data may be collected automatically, or manually and the plant data may also include any data that is derived or extrapolated from the collected plant data. The term “first plant data” may refer to plant data collected by a first grower device. The term “second plant data” may refer to plant data collected by a second grower device. The plant data may include, without limitation, environmental data, the plant strain, the planting date, the plant's name, breeder information, photos of the plant, and notes related to the plant. The environmental data includes, without limitation, information about the plant's surroundings, such as temperature, pH, and humidity.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

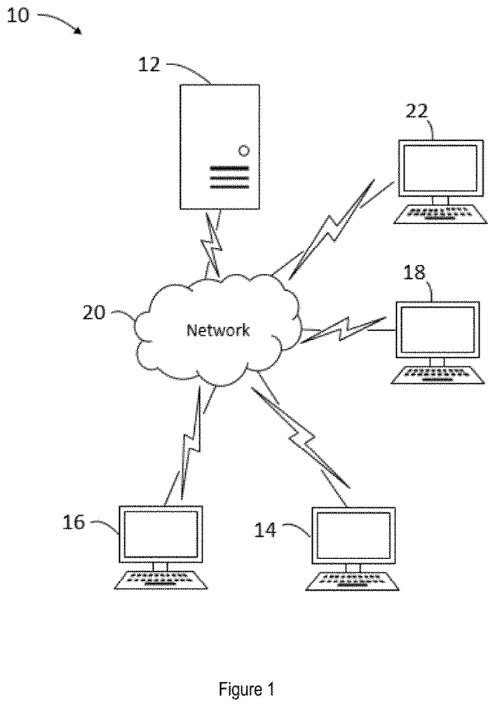

Referring to FIG. 1, illustrated therein is a block diagram illustrating a computer system for transferring plant data 10, in according to an embodiment.

The system 10 includes a second grower device 14. The second grower device 14 further is for growth of a plant after growth of the plant in a first grower device. The second grower device 14 collects second plant data related to growth of the plant in the second grower device 14. The second grower device 14 sends the plant data to the plurality of user devices 16, 18, 22 via the network 20. One second grower device 14 and three user devices 16, 18, 22 are shown, however any number of second grower devices and user devices one may be possible in the system.

The system 10 also includes a server 12 configured to receive and store second plant data transmitted by the user devices 16, 18, 22.

The system 10 includes a server platform 12 which communicates with the user devices 16, 18, 22 via a network 20. The server platform 12 also communicates with the second grower device 14. The server platform 12 may be a purpose built machine designed specifically for managing plant data.

The server platform 12, second grower devices 14 and user devices 16, 18, 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In the description that follows, devices such as server platform 12, second grower devices 14 and user devices, 16, 18, 22 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18, 22 may send information to the server platform 12. For example, a user using the user device 22 may manipulate one or more input devices (e.g. a mouse and a keyboard) to interact with a user interface displayed on a display of the user device 22. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the second grower devices 14 and user devices 16, 18, 22. Generally, the information may comprise at least an identifier identifying the second grower device 14 or user. For example, the information may comprise one or more of a username, e-mail address, password, or social media handle.

In response to receiving information, the server platform 12 may store the information in storage database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The second grower devices 14 may be associated with a respective plurality of grower device accounts. Similarly, each of the user devices 16, 18, 22 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

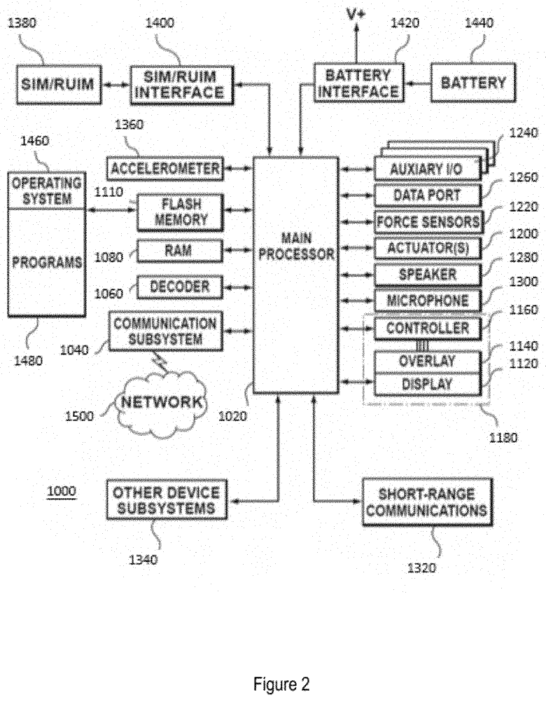

Referring to FIG. 2, illustrated therein is a simplified block diagram of components of a mobile device or portable electronic device 1000, according to an embodiment. The portable electronic device 1000 includes multiple components such as a processor 1020 that controls the operations of the portable electronic device 1000. Communication functions, including data communications, voice communications, or both may be performed through a communication subsystem 1040. Data received by the portable electronic device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The portable electronic device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the portable electronic device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The portable electronic device 1000 also includes an operating system 1460 and software components 1480 that are executed by the processor 1020 and which may be stored in a persistent data storage device such as the flash memory 1100. Additional applications may be loaded onto the portable electronic device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

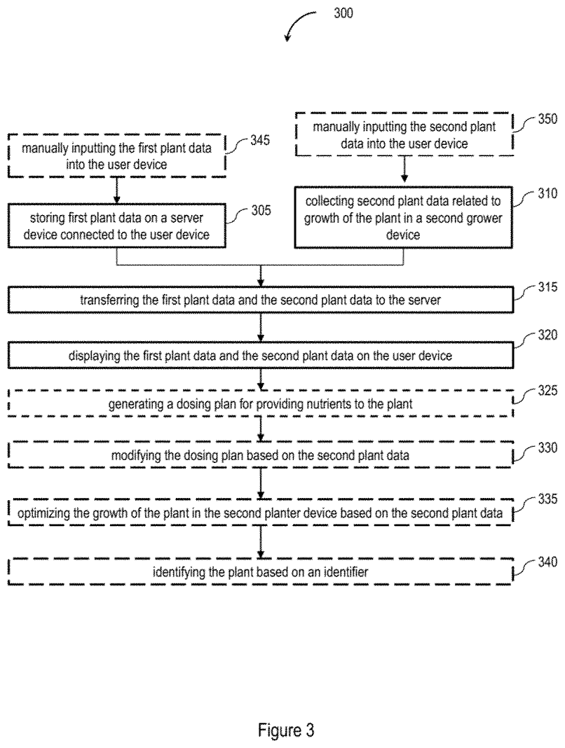

Referring to FIG. 3, illustrated therein is a flowchart demonstrating a computer-implemented method 300 of managing plant data, according to an embodiment. The method 301 includes storing first plant data on a user device connected to a server, at 305. The first plant data relates to growth of a plant in a first grower device. The method 300, also includes collecting second plant data related to growth of the plant in a second grower device, at 310. The second grower device is for growth of the plant moved from the first grower device. The second plant data is collected by a sensor of the second grower device. The method 300 also includes transferring the first plant data and the second plant data to the server, at 315. The method 300, also includes displaying the first plant data and the second plant data on the user device, at 320.

Optionally, the method 300 may include generating a dosing plan for providing nutrients to the plant, at 325. The dosing plan is generated based on the first plant data. Optionally, the method 300 may include modifying the dosing plan based on the second plant data, at 330.

Optionally, the method 300 may include optimizing the growth of the plant in the second grower device based on the second plant data, at 335.

Optionally, the method 300 may include identifying the plant based on an identifier, at 340. The identifier may be a QR code or a barcode.

Optionally, the method 300 may include manually inputting the first plant data into the user device, at 345.

Optionally, the method 300 may include manually inputting the second plant data into the user device, at 350.

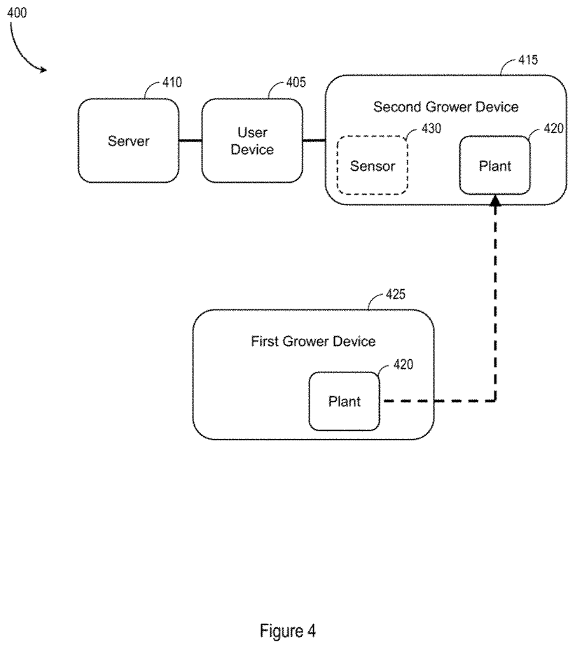

Referring to FIG. 4, illustrated therein is a block diagram demonstrating a computer system 400 for managing plant data, according to an embodiment. The system 400 includes a user device 405 for storing first plant data and second plant data. The first plant data is related to growth of a plant 420 in a first grower device. The system also includes a server 410 connected to the user device. The server 410 is configured to receive the first plant data and the second plant data from the user device 405. The system 400 also includes a second grower device 415 for growth of the plant 420 after growth of the plant 420 in the first grower device 425. The second grower device 415 collects second plant data, optionally the second plant data is collected by a sensor 430. The second plant data is related to growth of the plant in the second grower device 415. The second grower device 415 sends the plant data to the user device 405.

In some embodiments, the system 400 uses an event-driven decision making system that optimizes transplants of plants from the first grower device 425 to the second grower device 415 by automatically applying system behaviour modifications to each grower device. Accordingly the first grow in the first grower device 425 will end and the next grow in the second grower device 415 will begin right where the first grower device 425 left off.

Prior to transplant of the plant 420 from the first grower device 425 to the second grower device 415, data may be collected manually and automatically. Data may include, without limitation, date planted, water changes, nutrients added, plant height, plant 420 photos, growing notes, and plant genetics. The plant genetics may include, without limitation the breeder of the plant and the type of plant.

After transplanting the plant 420 from the first grower device 425 to the second grower device 415, a grow process, which is a predefined system behavior, may be applied to the second grower device 415. The recipe in the second grower device 415 picks up where a grow recipe in the first grower device 425 is left off. All first plant data from the first grower device 425 may be copied to the second grower device 415. The first plant data may be sent to the user device 405 or entered manually into the user device 405.

The grow process may include, without limitation, a stage length, a grow length, a nutrient dosing amount, a nutrient dosing frequency, a nutrient dosing type, an LED spectrum value intensities, and a pH target value. All user photos and notes (grow journals) transfer to the new system and can be entered from that grow page. The grow process in the first grower device 425 may then be terminated. The first grower device 415 may then receive a new plant for growing and the user device 405 may send a new grow process to the first grower device 415 for the new plant. The user device 405 may send a new grow process to the first grower device 415 for the new plant. The first grower device 415 may then be cleaned. New growing medium may be added and then and new seeds may be planted in the new growing medium to begin germinating and growing plants again.

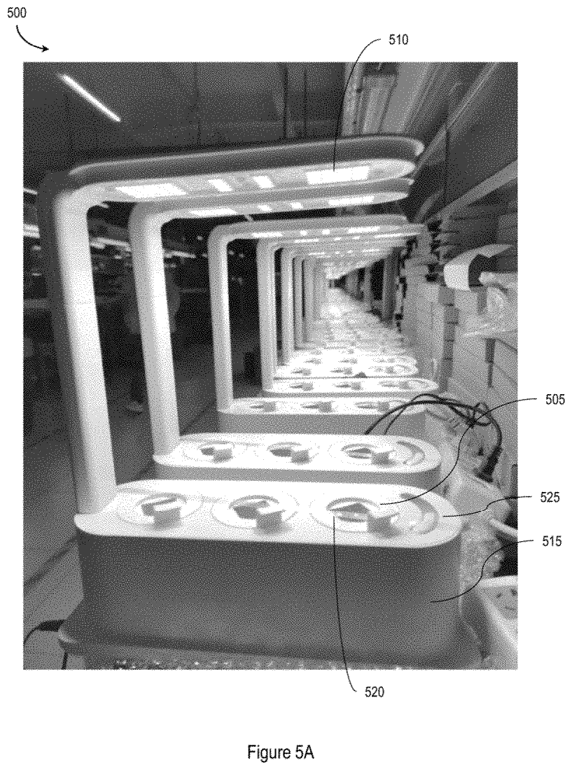

Referring to FIG. 5A, illustrated therein is a front view of a plurality of first grower devices 500, according to an embodiment. The first grower device 500 includes a first growth compartment 505 for growth of a plant from a seed. The first grower device 500 also includes a chamber 515 for storing a liquid nutrient solution. The first grower device 500 includes an LED light 510 for providing light to plants growing in the first growth compartment 505. The first grower device 500 also includes a top cover 525 which is removable for accessing the inside of the chamber 515.

In some embodiments, the first grower device may be designed for starting seeds or for growing small plants, greens, or herbs. The first grower device 500 may be used for the first 3-6 weeks of a plant's life prior to transplanting the plant into a second grower device. Optionally, the first grower device 500 may grow small plants, such as herbs or greens, for the entire life of the plant. In some embodiments, the first grower device 500 may not have sensors or WiFi connectivity. An application running on a user device may be used to control the functions of the first grower device 500.

The first growth compartment 505 includes a tray 520 for holding a growth medium. The growth medium may be any substance suitable for growing a plant or seed. For example, the growth medium may include, without limitation, soil, peat moss, coconut husk, foam, clay, rockwool, or any combination thereof. In some embodiments, the first grower device 500 may include a pump for delivering the liquid nutrient solution to the first growth compartment 505. In another embodiment, the growth compartment 505 is recessed, such that the growth medium is in constant contact with the liquid nutrient solution in the chamber 515.

Referring to FIG. 5B, illustrated therein is a perspective view of the first grower devices 500 from FIG. 5A with the growing tray 520 removed, according to an embodiment. The tray 520 is removeable and to allow for fast and easy transplanting of plants. However, in some embodiments, the tray 520 may be permanently attached to the first growth compartment 505.

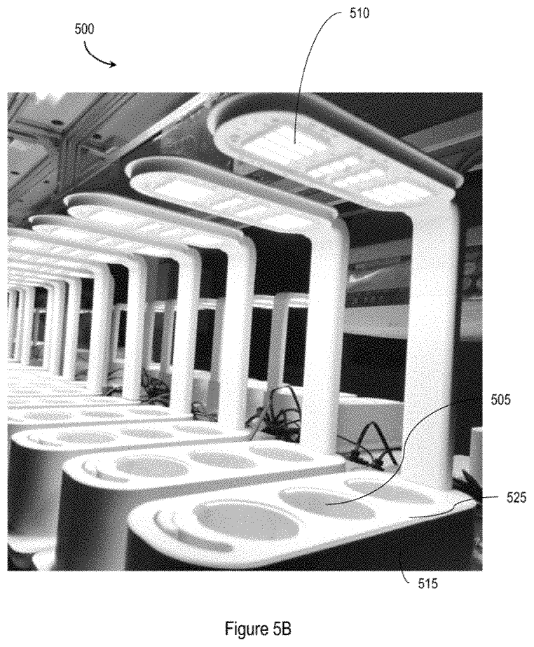

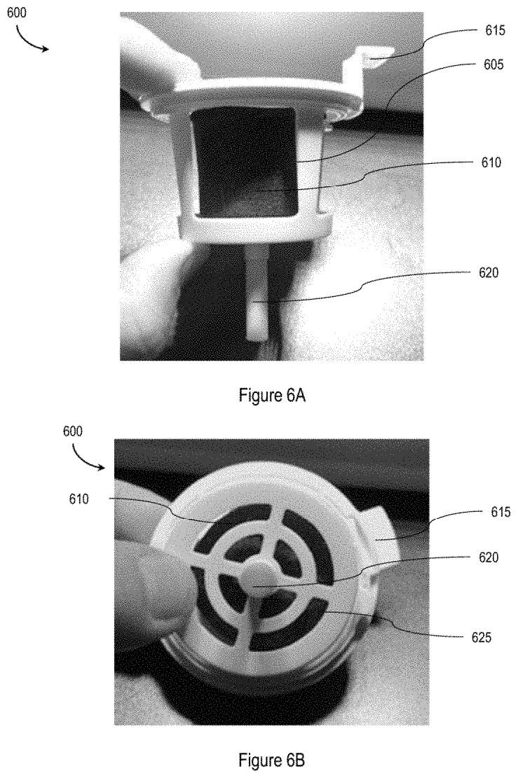

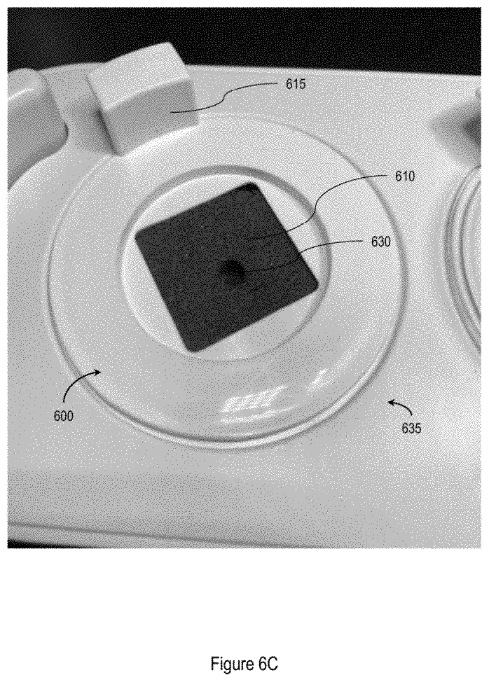

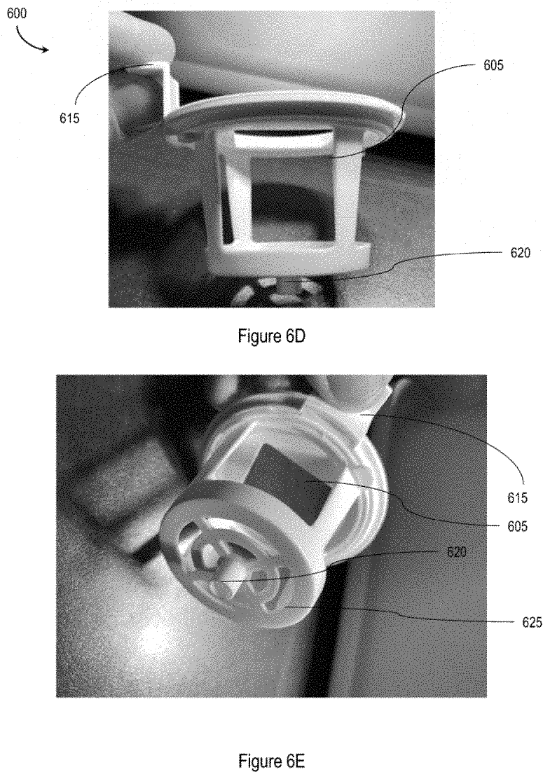

Referring to FIG. 6A, illustrated therein is a side view of a tray 600 of a first grower device with growth medium 610, according to an embodiment. The tray 600 has openings 605 along the sides to allow for roots of a plant to grow out through. The openings 605 along the sides may also allow for the liquid nutrient solution in the chamber to make contact with the growth medium 610. The tray 600 also includes a lip 615 for easier lifting of the tray 600 out of a first growth compartment. The tray 600 also includes a wick 620 at the bottom of the tray that helps with water uptake when the water level is low and no roots have grown

Referring to FIG. 6B, illustrated therein is a bottom-up view of the tray 600 from FIG. 6A, according to an embodiment. The tray 600 also includes openings 625 along the bottom of the tray 600. The openings 625 along the bottom serve a similar function as the openings 605 along the sides, however the openings 625 are smaller than the openings 605 along the side such that the growth medium does not fall out of the bottom of the tray 600. The tray 600 makes it easier to move a plant between grower devices and growth compartments.

Referring to FIG. 6C, illustrated therein is a perspective view of the tray 600 from FIG. 6A inside a first growth compartment 635, according to an embodiment. The growth medium 610 includes a divet 630 for placement of a seed to be grown into a plant. The lip 615 sticks upwards to allow for an easy point for removing the tray 600 from the first growth compartment 635.

Referring to FIG. 6D, illustrated therein is a side view of a tray 600 of a first grower device without growth medium 625, according to an embodiment. Referring to FIG. 6E, illustrated therein is a perspective view of the tray 600 from FIG. 6D. The tray 600 may be made from any material suitable for plant growth. In some embodiments, the material of the holder may include, without limitation, plastic, wood, metal, or any combination thereof.

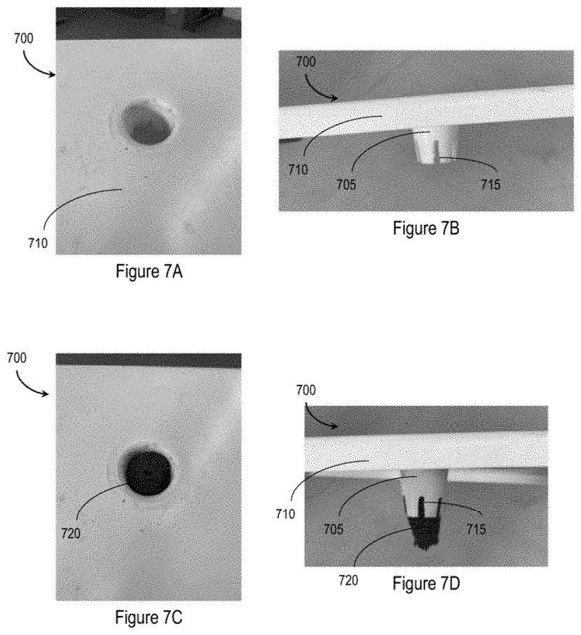

Referring to FIG. 7A, illustrated therein is a perspective view of another embodiment of a tray 700 of the first growth compartment. Referring to FIG. 7B, illustrated therein is a side view of the tray 700 of FIG. 7A, according to an embodiment. The tray 700 has an open bottom with tapered sides 705 for holding growth medium and the plant. The tray is incorporated into the top cover 710 of the first grower device.

Referring to FIG. 7C, illustrated therein is a perspective view of the tray 700 of FIG. 7A with growth medium. FIG. 7D illustrates a side view of the tray 700 of FIG. 7A with growth medium. The tapered sides 705 include teeth 715 which flex slightly and lock growth medium 720 in place such that the growth medium 720 does not fall out of the tray 700. The growth medium 720 extends out slightly from the open bottom of the tray 700 and roots of the plant may grow to extend through the open bottom as well.

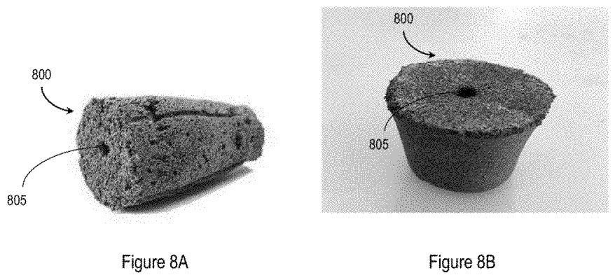

Referring to FIG. 8A, illustrated therein is a growth medium 800 for growing a seed in a first growth compartment, according to an embodiment. Referring to FIG. 8B, illustrated therein is another embodiment of the growth medium 800 in FIG. 8A. The growth medium 800 may be any substance suitable for growing a plant or seed. For example, the growth medium may include, without limitation, soil, peat moss, coconut husk, or any combination thereof. The growth medium 800 includes a divet 805 for placement of a seed for growth into a plant. The growth medium 800 retains a substantially solid shape which is compatible with the shape of the of a tray in the first growth compartment. The growth medium allows for easy transplanting of the plant between grower devices. The growth medium may expand when water is added. The growth medium may be at least partially porous to allow roots to grow through the growth medium. The material which the growth medium is comprised of may be inert and may or may not have a nutrient profile. For example, a growth medium made from foam is completely inert. In another example, a growth medium made from coconut husk or peat moss has nutrients relevant for plant growth. The growth medium may be used with either the first grower device or the second grower device. The growth medium may be any size or shape compatible with the first growth compartment or second growth compartment. Further, the growth medium may be used for growing a plant from a seed, or for growing a plant at any stage of the plant's life cycle.

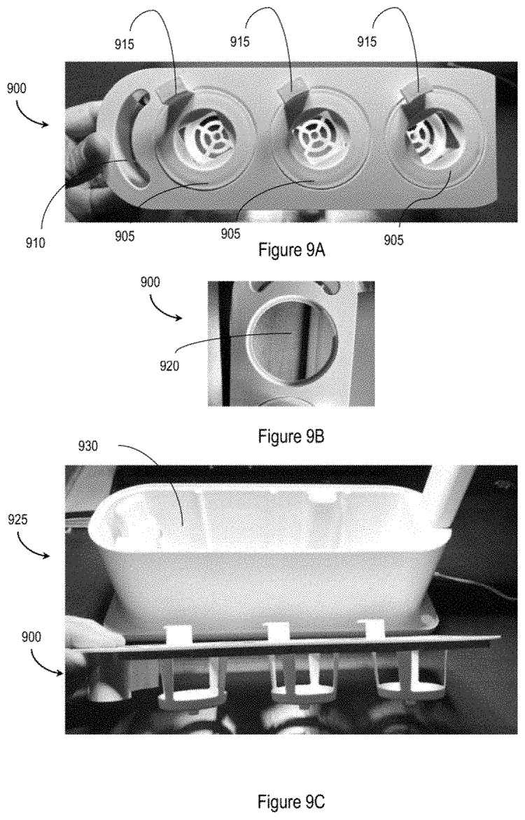

Referring to FIG. 9A, illustrated therein is a top cover 900 of the first grower device with three trays 905 placed in the top cover 900, according to an embodiment. While three trays 905 are shown, the top cover 900 may include any number of trays 905 which is compatible with the top cover 900. The trays 905 are removed by a lip 915 which extends out of the tray 905 for easy transplanting of the plant. The top cover 900 also includes a curved cut out 910 for a floating water level sensor. The floating water level sensor rises up and floats when the water tank is full. As the tank empties and the water level drops the floating water level sensor lowers down. The floating water level sensor is shown in FIGS. 5A, 5B, and 9C.

Referring to FIG. 9B, illustrated therein is the top cover 900 of FIG. 9A without a tray, according to an embodiment. The top cover 900 has a compatible cut out 920 which is a complementary shape to the tray 905. When the top cover 900 is placed in the first grower device 925, the cut out 920 is the first growth compartment.

Referring to FIG. 9C, illustrated therein is a side view of the top cover 900 of FIG. 9A, according to an embodiment. The top cover 900 is shown in front of a first grower device 925. The top cover 900 is placed above the chamber 930 of the first grower device 925. When plants are grown inside the tray 915, the tray 915 may be easily removed and transplanted in a second grower device or another first grower device 925. The server collects the first plant data and second plant data from the first and second grower devices, if the user moves the plant from a first grower device to another first grower device, the server associates the first plant data collected from the old first grower device with the new first grower device. The same process may be used for a plant moved from a second grower device to another second grower device.

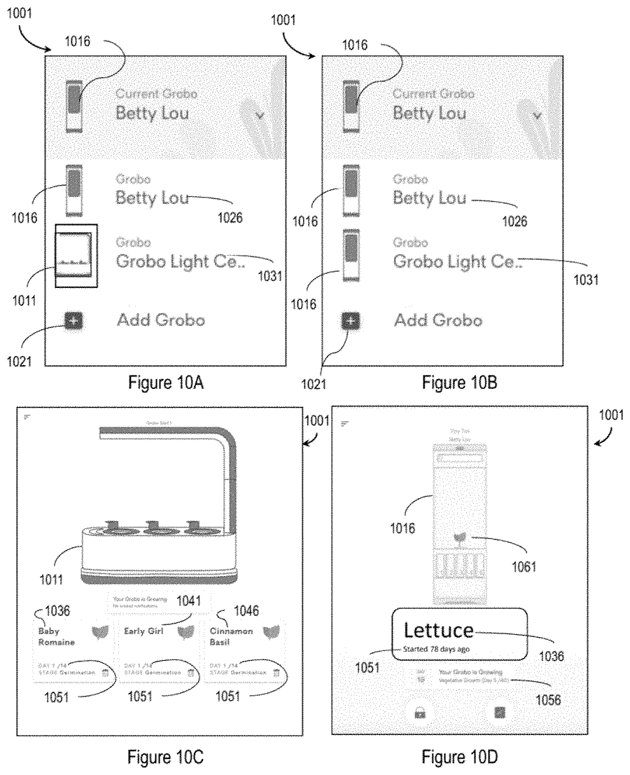

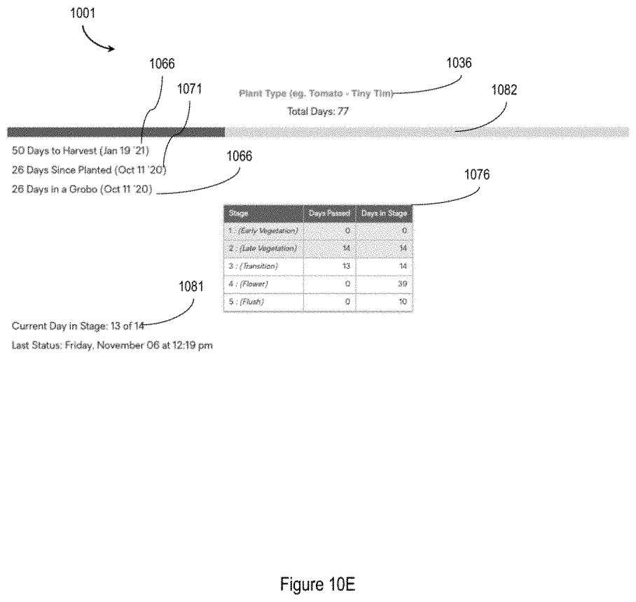

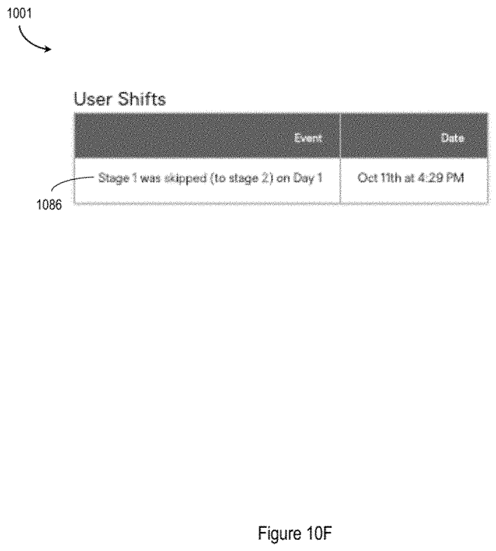

Referring to FIG. 10A, illustrated therein is a user interface 1001 on a user device for an application which controls the system for managing plant data, according to an embodiment. The user interface 1001 includes information regarding each first grower device 1011 and each second 1016 grower device associated with a user account. Additional first 1011 or second 1016 grower devices may be added if the user clicks on the “Add Grobo” icon 1021. The user interface 1001 also includes a nickname for each first 1011 or second grower device 1016. The nickname may be a custom nickname 1026 or a default nickname 1031 provided by the system.

Referring to FIG. 10B, illustrated therein is the user interface 1001 of FIG. 10A where a user does not have any first grower devices and only has second grower devices, according to an embodiment. A user may not possess any first grower devices 1011 and only possess second grower devices 1016. Accordingly, first plant data may be transferred to the user device or server to incorporate with the second plant data from the second grower devices. The first plant data may be manually input into the user interface 1001 of the user device, or the first plant data may be obtained automatically from the first grower device 1011.

Referring to FIG. 10C, illustrated therein is the user interface 1001 of FIG. 10A showing each plant being grown in the first grower device 1011, according to an embodiment. Each plant is displayed with first plant data such as the plant type 1036, 1041, 1046 of the plant. The first plant data may also include the plant's growth stage and the number of days the plant has been in the plant growth stage 1051, which is also displayed underneath the plant type 1036, 1041, 1046 of each plant.

Referring to FIG. 10D, illustrated therein is the user interface 1001 of FIG. 10A showing plant data of a single plant being grown in the second grower device, according to an embodiment. The user interface 1001 displays the second plant data of the plant growing in the second grower device 1016, such as the growth stage 1056 of the plant. A visual representation 1061 is also provided of the growth of the plant.

In some embodiments, the user interface may display system information, such as the name of the first grower device or the name of the second grower device. The system information may include the name of the user and the date the first grower device or second grower device was first connected to the user device or server. The system information may also include the user's time zone, which may be determined automatically or entered manually by the user. The system information may also include warranty information such as time left until a user warranty for the device has expired. The system information may also include the firmware version number and information.

Referring to FIG. 10E, illustrated therein is the user interface of FIG. 10A showing tracking of growth of a plant, according to an embodiment. The growth tracking for plants grown in either a first grower device or a plant grown in a second grower device. The user interface 1001 shows the number of days until a plant is harvested, at 1066. The number of days until the plant is harvested is calculated using either the first plant data, the second plant data, or both. The user interface 1001 also displays the number of days since the plant was planted, or the age of the plant, at 1071. The user interface 1001 also displays the number of days since the plant was planted in the first grower device or second grower device, at 1066. The application also displays information related to which stage the plant of growth the plant is currently in, at 1076. and how many days the plant has been in its current stage of growth, at 1081. In some embodiments, the information is based on the plant data received from the user, the first planter device, or the second planter device. The application 1001 also displays the plant's type 1036 and a visual progress bar 1082 to represent the plant's growth in the plant's life cycle.

Referring to FIG. 10F, illustrated therein is the user interface of FIG. 10A showing tracking of a user-initiated grow recipe, according to an embodiment. The application 1001 displays plant growth stages the user has opted to skip, at 1086. A user may manually input plant data such as the plant's growth stage to initiate a grow recipe specific for the plant at the growth stage the user manually inputs. In some embodiments, a grow recipe may include, without limitation, a dosage plan, length of a growth stage, LED colours, light duration, air flow control, which notification to send, or any combination thereof.

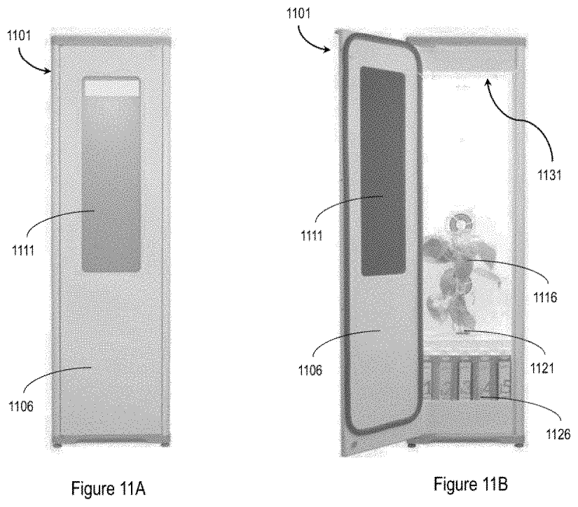

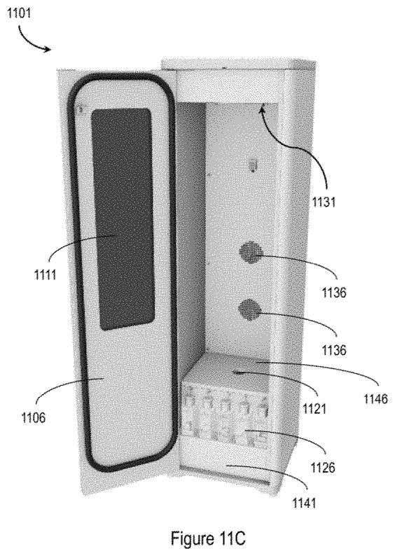

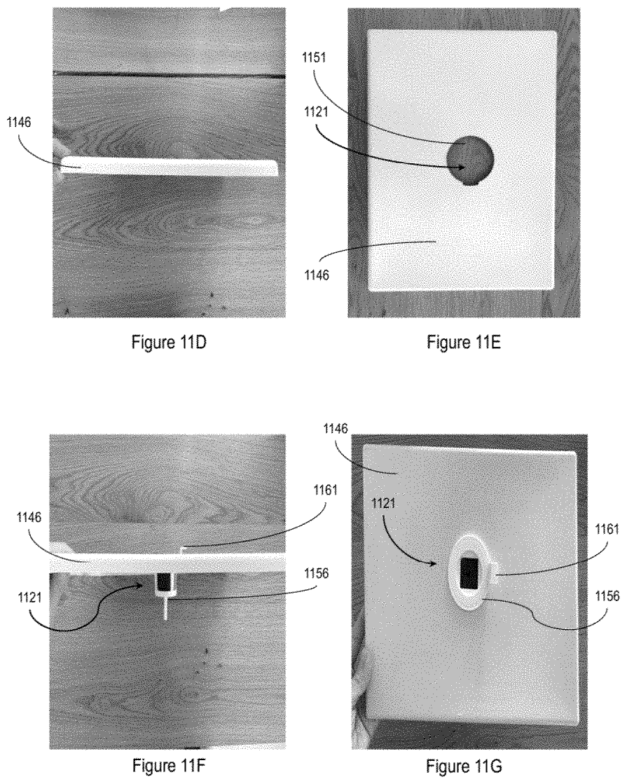

Referring to FIG. 11A, illustrated therein is a second grower device 1101 in an closed configuration, according to an embodiment. The second grower device 1101 includes a door 1106 which may be opened or closed such that the second grower device is in an open or closed configuration respectively. The door 1106 includes a window 1111 to allow a user to view the growth of the plant 1116 without opening the door 1106 of the second grower device 1101. In some embodiments, the door may include a lock for locking the second grower device 1101.

A plantar apparatus is described in U.S. Pat. No. 10,785,922 B2 to Thiele, having a filing date of May 3, 2018, which is herein incorporated by reference in its entirety.

Referring to FIG. 11B, illustrated therein is a front view of the second grower device 1101 of FIG. 11A in an open configuration, according to an embodiment. Referring to FIG. 11C, illustrated therein is a perspective view of the second grower device 1101 of FIG. 11A in an open configuration without a plant, according to an embodiment. The second grower device has a second growth compartment 1121 which is larger than the first growth compartment of the first grower device. The plant 1116 is accordingly moved to the second grower device 1101 when the plant 1116 grows to a stage that is too large for the first grower device. The second grower device also includes a chamber 1126 for storing a liquid nutrient solution. The second grower device includes LED lights 1131 for providing light at a necessary wavelength to the plant 1116. In some embodiments, the LED lights 1131 are multispectrum LED lights.

The second grower device 1101 also includes at least one sensor for collecting second plant data. The second plant data relates to growth of the plant in the second grower device. For example, the second plant data may include environmental temperature of the plant 1116, environmental humidity of the plant 1116, pH levels of growth medium and the liquid nutrient solution, electrical conductivity of the growth medium and the liquid nutrient solution, and the LED temperature.

The second grower device uses a grow process which is specific to the plant and based on the first plant data and the second plant data to optimize the growth of the plant. For example, the second grower device may modulate the LED lighting, pH of the liquid nutrient solution, or electrical conductivity of the liquid nutrient solution based on second plant data to optimize growth of the plant.

The second grower device 1101 also includes dual intake fans which allows for air drying a plant growing in the second grower device 1101. The second grower device 1101 may also includes a smell reducing carbon filter to reduce plant oders released from plants growing in the second grower device.

Referring to FIG. 11D, illustrated therein is a side view of the top cover 1146 of FIG. 11B without a tray, according to an embodiment. Referring to FIG. 11E, illustrated therein is a top down view of the top cover 1146 of FIG. 11C without a tray, according to an embodiment. The top cover 1146 has a compatible cut out 1151 which is a complementary shape to the tray 1156. When the top cover 1146 is placed in the second grower device 1101, the cut out 1151 is the first growth compartment.

Referring to FIG. 11F, illustrated therein is a side view of the top cover 1146 of the second grower device of FIG. 11C with one tray 1156 placed in the top cover 1146, according to an embodiment. Referring to FIG. 11G, illustrated therein is a top down view of the top cover 1146 of the second grower device of FIG. 11C with one tray 1156 placed in the top cover 1146, according to an embodiment. While one tray 1156 is shown, the top cover 1146 may include any number of trays 1156 which are compatible with the top cover 1146. The tray 1156 is removed by a lip 1161 which extends out of the tray 1156 for easy transplanting of the plant 1116. The tray is shown holding growth medium for growing a plant.

While the above description provides examples of one or more apparatus, methods, or systems, it will be appreciated that other apparatus, methods, or systems may be within the scope of the claims as interpreted by one of skill in the art.

1. A computer-implemented method of managing plant data, the method comprising:
storing first plant data on a user device to a server, wherein the first plant data relates to growth of a plant in a first grower device;
collecting second plant data related to growth of the plant in a second grower device, wherein the second grower device is for growth of the plant moved from the first grower device;
transferring the first plant data and the second plant data to the server; and
displaying the first plant data and the second plant data on the user device.

2. The method of claim 1, wherein the first plant data includes at least one of the group comprising plant strain, planting date, historical environmental data, a plant name, breeder information, photos of the plant, and notes related to the plant.

3. The method of claim 1, wherein the second plant data is collected by a sensor of the second grower device.

4. The method of claim 1 further comprising generating a dosing plan for providing nutrients to the plant, wherein the dosing plan is generated based on the first plant data; and modifying the dosing plan based on the second plant data.

5. The method of claim 1, further comprising identifying the plant based on an identifier; and wherein the identifier is a QR code or a barcode.

6. A computer system for managing plant data, the system comprising the user device of claim 1, the server of claim 1, and the second grower device of claim 1.

7. A system for growing plants, the system comprising:
a user device for receiving second plant data;
a first grower device operably controlled by the user device, the first grower device comprising:
a first growth compartment for growth a plant from a seed; and
a chamber for storing a liquid nutrient solution; and
a second grower device for receiving the plant grown in the first grower device, wherein the second grower device is operably controlled by the user device, wherein the second grower device collects second plant data related to growth of the plant in the second grower device, wherein the second grower device comprises:
a second growth compartment larger than the first growth compartment; and
a chamber for storing a liquid nutrient solution.

8. The system of claim 7, wherein the first grower device further comprises at least one sensor for collecting first plant data, wherein the first plant data relates to growth of the plant from a seed in the first grower device.

9. The system of claim 7, wherein the first plant data includes at least one of the group comprising plant strain, planting date, a plant name, breeder information, photos of the plant, and notes related to the plant.

10. The system of claim 7, wherein the second grower device further comprises at least one sensor for collecting first plant data, wherein the first plant data relates to growth of the plant from a seed in the first grower device.

11. The system of claim 7, wherein the server generates a dosing plan for providing nutrients to the plant, wherein the dosing plan is generated based on the first plant data; and wherein a server modifies the dosing plan based on the second plant data.

12. The system of claim 7, wherein the first growth compartment further comprises a removable tray.

13. The system of claim 12, wherein the removable tray is compatible with the second growth compartment and is for transferring the plant from the first grower device to the second grower device.

14. A method for growing plants, the method comprising:
removing a tray containing a plant from a first growth compartment of a first grower device;
moving the tray containing the plant to a second grower device for receiving the plant grown in the first grower device, wherein the second grower device collects second plant data related to growth of the plant in the second grower device; and
placing the tray containing the plant in a second growth compartment of the second grower device, wherein the second growth compartment is larger than the first growth compartment, wherein the tray is physically compatible with both the first growth compartment and the second growth compartment.

15. The method of claim 14, further comprising:
storing first plant data on a user device to a server, wherein the first plant data relates to growth of a plant in a first grower device;
transferring the first plant data and the second plant data to the server; and
displaying the first plant data and the second plant data on the user device

16. The method of claim 15, wherein the first plant data includes at least one of the group comprising plant strain, planting date, historical environmental data, a plant name, breeder information, photos of the plant, and notes related to the plant.

17. The method of claim 15 further comprising generating a dosing plan for providing nutrients to the plant, wherein the dosing plan is generated based on the first plant data; and modifying the dosing plan based on the second plant data.

18. The method of claim 15 further comprising manually inputting the first plant data into the user device.

19. The method of claim 15, wherein the first plant data is collected by the first grower device prior to storing the first plant data on the user device.

20. The method of claim 15, further comprising identifying the plant based on an identifier.
